(19) United States
(12) Patent Application Publication
(10) Pub. No.: US 2026/0107329 A1
(43) Pub. Date: Apr. 16, 2026

(54) MULTI-USER ENHANCED DISTRIBUTION CHANNEL ACCESS PER TRAFFIC IDENTIFIER/TRAFFIC STREAM

(71) Applicant: Cisco Technology, Inc., San Jose, CA (US)

(72) Inventors: Binita Gupta, San Diego, CA (US); Malcolm M. Smith, Richardson, TX (US); Brian D. Hart, Sunnyvale, CA (US)

(21) Appl. No.: 19/276,292

(22) Filed: Jul. 22, 2025

Related U.S. Application Data
(60) Provisional application No. 63/706,916, filed on Oct. 14, 2024.

(51) Int. Cl. H04W 74/08

(52) U.S. Cl. CPC H04W 74/0866

(57) ABSTRACT

A wireless station performs a method involving: upon receiving, from an access point, a fine-granularity trigger frame that includes one or more traffic flow identifiers (TFIDs) mapped to an access category, responding to the fine-granularity trigger frame with traffic for the access category; and implementing modified Multi-User Enhanced Distribution Channel Access (MU EDCA) per TFID for the access category based on at least the one or more TFIDs, wherein the modified MU EDCA per TFID includes: applying MU EDCA for an MU EDCA time duration to the one or more TFIDs in the fine-granularity trigger frame; and during the MU EDCA time duration, applying EDCA to one or more other TFIDs of the access category that are not in the fine-granularity trigger frame.

### CROSS REFERENCE TO RELATED APPLICATION

This application claims priority to U.S. Provisional Ser. No. 63/706,916 , filed Oct. 14, 2024, the entirety of which is incorporated herein by reference.

### TECHNICAL FIELD

The present disclosure relates to wireless networks.

### BACKGROUND

In the baseline IEEE 802.11 standard specification, Multi-User Enhanced Distribution Channel Access (MU EDCA) rules are defined per Access Category (AC), i.e., at the level of the AC, not lower. If a wireless station (STA) is triggered by an access point (AP) using a Trigger frame and sends an uplink Quality of Service (UL QoS) data frame for one or more ACs, then MU EDCA rules apply for that STA for those ACs for which the STA sent QoS data frames. The most common way to apply MU EDCA is to set the Arbitration Interframe Space Number (AIFSN) field to 0, which is a special value that indicates the disabling of EDCA operation for the corresponding AC for an MU EDCA Timer duration.

There is room for improvement and enhancement of the MU EDCA rules and processes.

### BRIEF DESCRIPTION OF THE DRAWINGS

FIG. 1 is a diagram of a wireless communication environment in which an access point (AP) communicates wirelessly with a plurality of wireless stations (STAs), according to an example embodiment.

FIG. 2 shows timing associated with Multi-User Enhanced Distribution Channel Access (MU EDCA) in a conventional scenario, according to an example embodiment.

FIG. 3 shows timing for modified MU EDCA according to an example embodiment.

FIG. 4 shows a first modified MU EDCA timing arrangement, according to an example embodiment.

FIG. 5 shows a second modified MU EDCA timing arrangement, according to an example embodiment.

FIG. 6 is a transaction diagram for modified MU EDCU performed by an AP and a STA, according to an example embodiment.

FIG. 7 shows message information elements related to modified MU EDCA, according to an example embodiment.

FIG. 8 is a flowchart of a method performed by the STA to implement modified MU EDCA, according to an example embodiment.

FIG. 9 is a flowchart of a method performed by the STA and the AP to implement modified MU EDCA, according to an example embodiment.

FIG. 10 is a flowchart of a method performed by the AP to enable modified MU EDCA at the STA and then monitor compliance of the STA, according to an example embodiment.

FIG. 11 illustrates a hardware block diagram of a device that may perform functions associated with operations discussed herein in connection with the techniques presented herein, according to an example embodiment.

### DESCRIPTION OF EXAMPLE EMBODIMENTS

### Overview

In an embodiment, a wireless station performs a method involving: upon receiving, from an access point, a fine-granularity trigger frame that includes one or more traffic flow identifiers (TFIDs) mapped to an access category, responding to the fine-granularity trigger frame with traffic for the access category; and implementing modified Multi-User Enhanced Distribution Channel Access (MU EDCA) per TFID for the access category based on at least the one or more TFIDs, wherein the modified MU EDCA per TFID includes: applying MU EDCA for an MU EDCA time duration to the one or more TFIDs in the fine-granularity trigger frame; and during the MU EDCA time duration, applying EDCA to one or more other TFIDs of the access category that are not in the fine-granularity trigger frame.

In another embodiment, a system comprises: an access point to perform transmitting a fine-granularity trigger frame that includes one or more traffic flow identifiers (TFIDs) mapped to an access category; and a wireless station (STA) to perform: responding to the fine-granularity trigger frame with traffic for the access category; and implementing modified multi-user (MU) Enhanced Distribution Channel Access (EDCA) (MU EDCA) per TFID for the access category based on at least the one or more TFIDs, wherein the modified MU EDCA per TFID includes: applying MU EDCA for an MU EDCA time duration to the one or more TFIDs in the fine-granularity trigger frame; and during the MU EDCA time duration, applying EDCA to one or more other TFIDs mapped to the access category that are not in the fine-granularity trigger frame.

In yet another embodiment, a method performed by an access point comprises: transmitting, to a wireless station (STA), a command to enable, at the STA, modified Multi-User Enhanced Distribution Channel Access (MU EDCA) per traffic flow identifier (TFID); transmitting, to the STA, a fine-granularity trigger frame that indicates one or more TFIDs mapped to an access category and to which the STA is to apply the modified MU EDCA per TFID; after receiving, from the STA, a Quality of Service (QoS) data frame responsive to the fine-granularity trigger frame, determining whether the STA is non-compliant with the modified MU EDCA per TFID; when the STA is non-compliant, taking correcting action with respect to the STA; and when the STA is compliant, not taking the corrective action.

### EXAMPLE EMBODIMENTS

In a wireless local area network (WLAN) or Wi-Fi® wireless network, one or more wireless access points (APs) provide wireless Radio Frequency (RF) coverage over which one or more wireless devices (e.g., phones, wearable devices, tablets, etc.) can connect to the APs in order to connect to one or more data networks (e.g., the public Internet, an enterprise network operated by an enterprise entity (e.g., a business, institution, university, etc.)), and/or the like.

Current WLAN/Wi-Fi standards, such as Institute of Electrical and Electronics Engineers (IEEE) 802.11 provide that when an AP sends uplink (UL) triggers to wireless stations (STAs), it specifies a Preferred AC (Access Class or Access Category) value in a Trigger frame. The preferred AC indicates the lowest AC for Medium Access Control (MAC) Protocol Data Units (MPDUs) that are recommended to be sent in response to the Trigger frame.

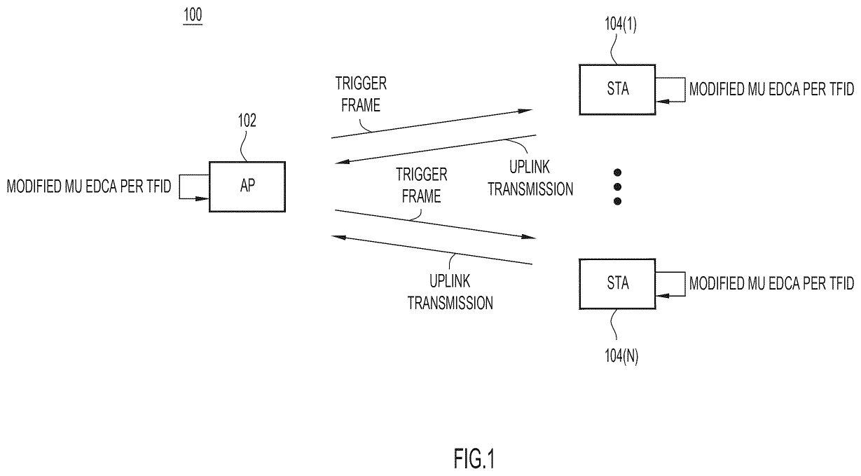

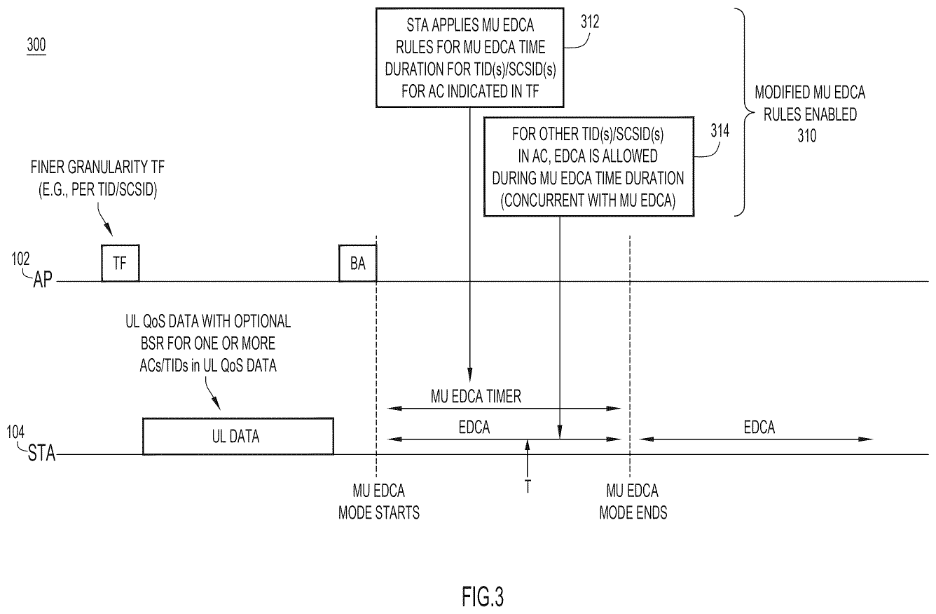

FIG. 1 shows a diagram of a wireless communication environment 100 in which an AP 102 communicates wirelessly with a plurality of STAs 104(1)-104(N) (collectively and individually referred to as “STAs 104” and “a STA 104,” respectively). The AP 102 initiates uplink orthogonal frequency division multiple access (OFDMA) multi-user (UL MU) operation by transmitting a Trigger frame. The Trigger frame includes information common to all the STAs 104 and then user information specific to individual STAs, including Resource Unit (RU) size, modulation and coding scheme (MCS), etc. The STAs 104 receive the Trigger frame and know which RUs to use when simultaneously transmitting, on the same channel, an uplink transmission to the AP 102. According to embodiments presented herein, the AP 102 and the STAs 104 cooperate to perform modified Multi-User Enhanced Distribution Channel Access (MU EDCA) per traffic flow (TF) identifier (ID) (TFID) (i.e., modified MU EDCA per TFID, also referred to simply as modified MU EDCA). In modified MU EDCA, generally, the AP 102 enables and triggers STAs 104 to implement/apply modified MU EDCA to traffic originated by the STAs 104, as described below in connection with FIGS. 3-10.

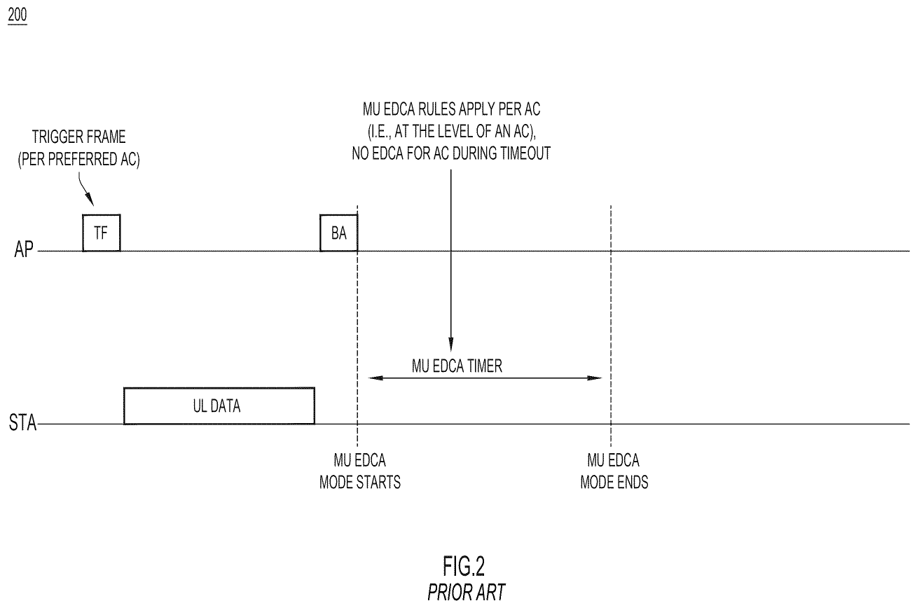

FIG. 2 shows example timing 200 associated with MU EDCA in a conventional scenario. In FIG. 2, the AP transmits a conventional Trigger frame (TF) for an AC, the STA transmits UL data in response to the conventional TF, and the AP transmits a block acknowledgement (BA) in response to the UL data. After the BA, the STA starts an MU EDCA timer (that counts an MU EDCA Time duration) that starts the MU EDCA mode. During the MU EDCA mode (i.e., during the MU EDCA time duration), the STA applies MU EDCA rules to traffic for the AC, and disables EDCA for the AC. Upon expiry of the MU EDCA timer (i.e., when the MU EDCA Time duration is over), the MU EDCA mode ends, the STA disables MU EDCA, and continues with EDCA. Thus, MU EDCA allows for temporary deprioritized access after an RU grant in a conventional TF. STAs that were granted RUs use MU EDCA parameters during MU EDCA Timer countdown, after which the regular EDCA mode may resume.

In the IEEE 802.11 standard, multiple Traffic Identifiers (TIDs) can be mapped to a given AC, baseline mapping two TIDs (from 0 to 7) to each AC. When the TID space is expanded to use the Traffic Stream Identifier (TSID) space (from value 8 to 15) as well, then more TSIDs can be mapped to a given AC. When a STA is triggered for UL transmission, the STA may only send QoS data frames for a subset of the TIDs/TSIDs mapped to a given AC. This can particularly be the case if more granular triggering is adopted where an AP can trigger based on specific TIDs/TSIDs/SCSIDs (generally referred to as traffic flow identifiers (TFIDs) for an AC), where SCSID is a Stream Classification Service Identifier. In this case, the Trigger frame may only result in the STA sending traffic for high priority SCS flow(s) mapped to an AC. Other flows/TIDs mapped to that AC may remain unserved if not enough resources are allocated by the AP. These resources may be defined in terms of Resource Unit (RU) size, number of spatial streams (NSS) and modulation and coding scheme (MCS), RU size*NSS*MCS. As used herein, the term TID may generally encompass both TID and TSID, and the term TFID (and TFIDs) may generally encompasses TID (including TSID) and SCSID.

As an example, when an AP triggers an SCS flow for an extended reality (XR) application mapped to AC_VI, then only that SCS flow may be served and another video streaming flow mapped to AC_VI may not be served due to insufficient resources allocated in the Trigger frame.

In such a case, since the STA was able to deliver traffic for only a subset of flow(s) mapped to a given AC in response to a Trigger frame, disabling EDCA for the entire AC is not desired as done in MU EDCA rules today, since other flows then are not served. Hence, with finer granular triggering, a mechanism and rules are desired to be defined that can enable the STA to perform EDCA for other flows mapped to an AC that were not served by a TF, but also keep fairness of MU EDCA operation. The techniques presented herein address this situation.

From a user point of view, this lag in capability impacts new Wi-Fi® wireless network use-cases such as augmented reality/virtual reality/extended reality (AR/VR/XR) and Industrial Internet Of Things (IIOT), where the latency bounds and scheduling intervals between traffic classes in the same AC are dramatically different and thus differentiation is important.

FIG. 3 shows example timing 300 for modified MU EDCA according to embodiments presented below. As shown, in modified MU EDCA, the Trigger frame is a finer granularity Trigger frame (also referred to as a fine-granularity (FG) Trigger frame (TF) (FG TF)) compared to the conventional Trigger frame. The term “finer granularity” (or “fine-granularity”) is used herein to refer to a Trigger frame that includes additional information to support TSID/TID based triggering and SCSID based triggering for each AC. Various signaling formats may be used for TID/TSID/SCSID based triggering to enable an IEEE 802.11/WLAN AP to trigger wireless devices, also referred to as clients or stations (STAs), for specific flows (e.g., mapped to TID, TSID, or SCSID (also referred to as SCS ID)).

In response to the finer granularity Trigger frame, the STA 104 transmits UL QoS data (i.e., QoS traffic), which may include an optional Buffer Status Report (BSR) for one or more ACs in the UL QoS data. In response to the UL QoS data, the AP 102 transmits a BA. Then, the STA 104 starts modified MU EDCA, as indicated at 310. The STA 104 applies MU EDCA rules (i.e., applies MU EDCA parameters) for an MU EDCA time duration to traffic for at least the TID(s)/SCSID(s) of an AC indicated in the TF, as indicated at 312. During the MU EDCA time duration (i.e., concurrent with the MU EDCA), The STA 104 also applies EDCA (i.e., EDCA parameters) to other TID(s)/SCSID(s) of the AC, and can transmit QoS traffic for the other TID(s)/SCSID(s) during the MU EDCA time duration, as indicated at 314. For example, when the EDCA acquires transmit access for QoS traffic for the other TID(s)/SCSID(s) of the AC at a time T before the MU EDCA time duration expires, the STA 104 transmits the QoS traffic during the MU EDCA time duration. As shown in FIG. 3, the modified MU EDCA timer can be enabled per TID/TSID/SCID if certain criteria are met, as described below.

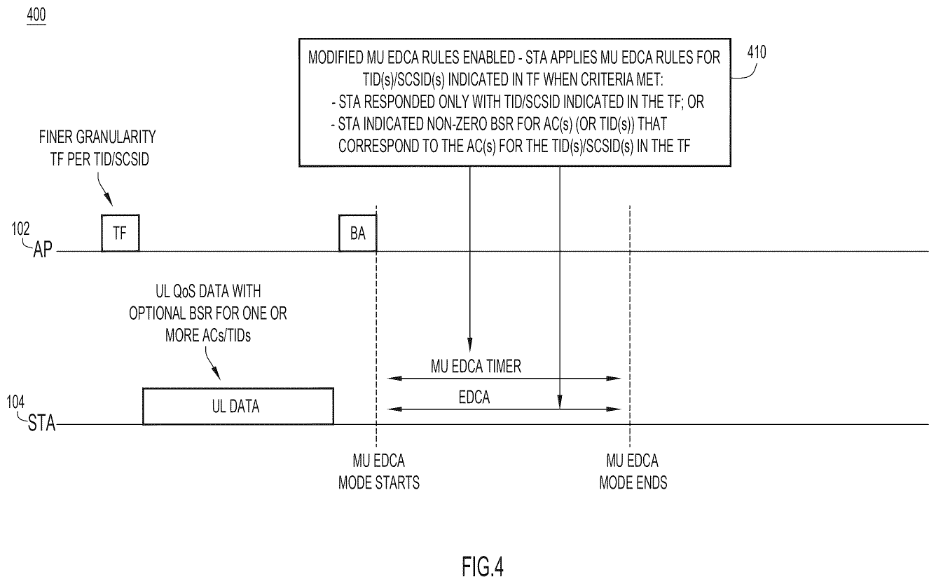

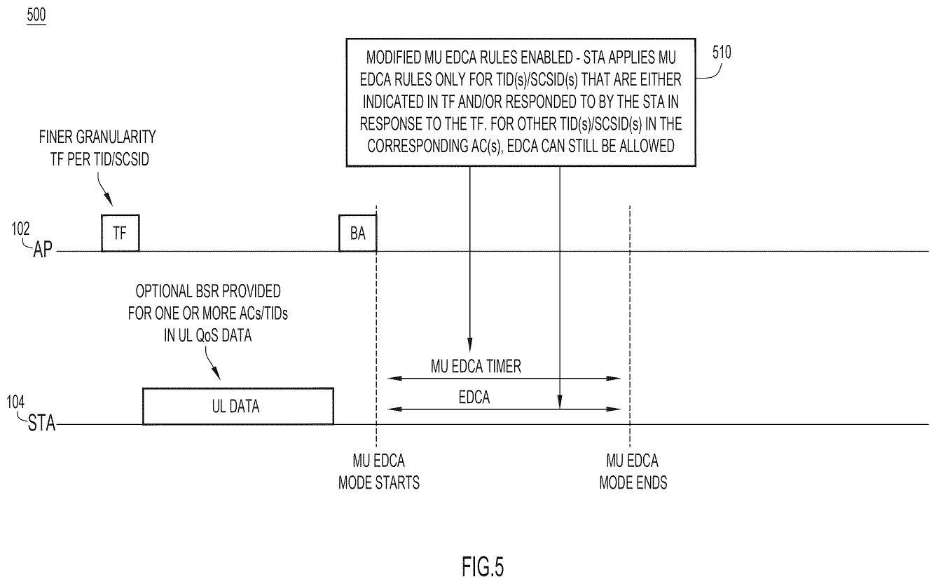

Reference is made to FIG. 3 for the description of the embodiments provided below. Additionally, specific example timing arrangements for modified MU EDCA are also described below in connection with FIGS. 4 and 5. In the ensuing description, references to an AP and a STA (or STAs) are understood to be references to AP 102 and STA(s) 104, although the reference numerals “102” and “104” may be dropped.

### Modified MU EDCA Rules per TID/TSID/SCSID (TFID)

Modified MU EDCA rules (i.e., rules for modified MU EDCA) are provided to deal with the aforementioned challenges as follows.

First, an AP can continue to use the current mechanism of sending Preferred AC based triggering for any TF. If the STA responds with QoS data frame for any of the ACs in response to such a Trigger frame, then the current MU EDCA rules apply and EDCA is disabled for those ACs for the MU EDCA Timer duration if AIFSN is set to 0. This expected behavior is indicated explicitly by a bit in the TF.

Second, if the AP and the STA both indicate support for finer granularity triggering (per TIDs/TSIDs/SCSIDs), and the AP sends a TF for triggering specific TIDs/TSIDs/SCSIDs, and if the STA only responds with QoS data frames for the indicated TIDs/TSIDs/SCSIDs in the TF, then the following rules can be applied.

The STA also provides a BSR in the QoS data frames for each of the ACs to which the indicated TIDs/TSIDs/SCSIDs in the TF and/or the responded TIDs/TSIDs/SCSIDs map.
a. If the BSR indicates a non-zero Queue size for one or more of those ACs, then the STA applies modified MU EDCA for those ACs. In the modified MU EDCA rules for an AC, the STA applies the MU EDCA Timer only for QoS data frames of TIDs/TSIDs/SCSIDs that were indicated in the Trigger frame and responded to by the STA in response to the TF. The STA continues to do EDCA for the corresponding AC and if EDCA backoff counts to zero (e.g., an EDCA backoff time expires) within the MU EDCA Timer duration, then the STA sends traffic of other TIDs/TSIDs/SCSIDs mapped to that AC, but does not send any MPDUs for TIDs/TSIDs/SCSIDs indicated in the Trigger frame and responded to by the STA.
b. On the other hand, if for one or more ACs, the BSR indicates zero Queue size, this means that all the traffic for that AC was served (i.e., the STA does not have any remaining traffic for that AC). In this case the current MU EDCA rules are applied and the STA disables EDCA for that AC for the MU EDCA Timer duration. In another embodiment, the STA disables EDCA for that AC only until the STA acquires some buffered traffic for TIDs/TSIDs/SCSIDs for that AC that were not reported in the BSR response to the TF. If the STA acquires traffic for any of these TIDs/TSIDs/SCSIDs during the MU EDCA Timer duration, then the STA enables the EDCA access for that AC and if the STA acquires channel access, the STA only sends traffic for TIDs/TSIDs/SCSIDs for that AC that were not responded to in response to TF.

Third, if the AP and the STA both indicate support for finer granularity triggering (per TIDs/TSIDs/SCSIDs), and the AP sends a TF for triggering specific TIDs/TSIDs/SCSIDs, and the STA responds with QoS data frames not only for indicated TIDs/TSIDs/SCSIDs but also for some other TIDs/TSIDs/SCSIDs, then the following rules can be applied.

In one embodiment, similar to the BSR based rules applied as above, the STA provides the BSR in the QoS data frames for each of the ACs to which the responded TIDs/TSIDs/SCSIDs map.
a. If the BSR indicates a non-zero Queue size for one or more of those ACs, then the STA applies modified MU EDCA for those ACs. The STA continues to do channel access for these ACs. In the modified MU EDCA rules for the AC, the STA applies the MU EDCA Timer only for the TIDs/TSIDs/SCSIDs that were sent in response to the Trigger frame and does not send any QoS data frames for these TIDs/TSIDs using EDCA during the MU EDCA Timer. For other TIDs/TSIDs mapped to that AC, the STA can send QoS data frames when EDCA channel access is acquired for that AC during the MU EDCA Timer duration.
b. If for one or more ACs, the BSR indicates zero Queue size, this means that all the traffic for that AC was served (i.e., the STA does not have any remaining traffic for that AC). In this case the current MU EDCA rules are applied and the STA disables EDCA for that AC for the MU EDCA Timer duration. Similar to above, in another embodiment, the STA disables EDCA for that AC only until the STA acquires some buffered traffic for TIDs/TSIDs/SCSIDs for that AC that were not responded to in response to the TF. If the STA receives traffic for any of these TIDs/TSIDs/SCSIDs during the MU EDCA Timer duration, then the STA enables the EDCA for that AC and if the STA acquires channel access, the STA only sends traffic for TIDs/TSIDs/SCSIDs for that AC that were not responded to in response to the TF.

In another embodiment, the modified MU EDCA rules apply for those TIDs/TSIDs/SCSIDs that were indicated in the finer granularity TF even if the STA does not send QoS data frames for those TIDs/TSIDs/SCSIDs and sends QoS data frames for other TIDs/TSIDs/SCSIDs. In other words, for the MU EDCA Timer duration, EDCA based uplink transmission cannot be performed for the TIDs/TSIDs/SCSIDs that were indicated in the finer granularity TF even if these were not responded to in response to the TF. This is sensible because the AP triggers based on SCS+QoS Characteristic element (QC) and has allocated RUs for those TIDs/TSIDs/SCSIDs, and the STA should respond with data frames for those TIDs/TSIDs/SCSIDs per SCS+QC.

In still another embodiment, when the STA responds with QoS data frames not only for indicated TIDs/TSIDs/SCSIDs but also for some other TIDs/TSIDs/SCSIDs, then the current MU EDCA rules apply and EDCA is disabled for ACs corresponding to the TIDs/TSIDs/SCSIDs responded by the STA for the MU EDCA Timer duration.

FIGS. 4 and 5 show a modified MU EDCA timing arrangement 400 and a modified MU EDCA timing arrangement 500, respectively, similar to FIG. 3, according to some of the embodiments described above. With reference to FIG. 4, in modified MU EDCA timing arrangement 400, the STA applies MU EDCA rules 410 for TID(s)/SCSID(s) indicated in the TF when the following criteria met: the STA responded only with TID(s)/SCSID(s) indicated in the TF; or the STA indicated non-zero BSR Queue size for AC(s) (or TID(s)) which correspond to the AC(s) for the TID(s)/SCSID(s) in the TF.

With reference to FIG. 5, in modified MU EDCA timing arrangement 500, the STA applies MU EDCA rules 510, such that the STA applies MU EDCA rules only for TID(s)/SCSID(s) that are either indicated in TF and/or responded to by the STA in response to the TF. For other TID(s)/SCSID(s) in the corresponding AC(s), EDCA can still be allowed.

### Enabling Modified MU EDCA per TID/TSID/SCSID (TFID)

The AP may indicate support for modified MU EDCA per TID/TSID/SCSID (i.e., for modified MU EDCA) in the Ultra High Reliability (UHR) Capabilities or another element e.g., in a Beacon, Probe Response or another management frame.

The STA may indicate support for modified MU EDCA in the UHR Capabilities or another element e.g., in (Re)Assoc Request, Probe Request or another management frame.

The AP can indicate that modified MU EDCA is enabled only for certain ACs and/or for certain TIDs/TSIDs in the BSS in the UHR Capabilities or UHR Operation or another element. The AP can indicate that modified MU EDCA is only enabled when the AP sends a finer granularity TF and is not enabled otherwise. The AP can also indicate that the modified MU EDCA should only be enabled for an AC if the BSR indicates non-zero Queue size for an AC when responding to a TF.

The AP can dynamically enable or disable support for modified MU EDCA through a Beacon or using Operating Mode Notification (OMN) or Operating Mode Indication (OMI) mechanisms.

For a specific TF, the AP can also indicate if modified MU EDCA is allowed/enabled either explicitly using a bit or implicitly using Preferred_AC based triggering, which disables use of modified MU EDCA for that TF and results in regular MU EDCA rules to be applied.

In another embodiment, the STA does not take into account whether modified MU EDCA based on BSR Queue size reported, but applies modified MU EDCA rules based on whether it was enabled by the AP in the BSS for that AC or for TID/TSID/SCSID or for that TF.

In still another embodiment, the AP and the STA negotiate to enable modified MU EDCA. The STA can request in the SCS Request to enable modified MU EDCA for the indicated TID/TSID/SCSID and/or the mapped AC in the SCS request. The AP can indicate whether it accepts a request to enable modified MU EDCA in the SCS Response. If the AP accepts, then the STA can apply modified MU EDCA for that TID/TSID/SCSID in the mapped AC. The AP can also indicate that it allows modified MU EDCA for some other or all TIDs/TSIDs/SCSIDs in that AC and can indicate that modified EDCA is applied only when a finer granularity TF is sent and can indicate that it requires BSR to be non-zero for the AC to enable modified MU EDCA for an AC.

### Encouraging STAs to Abide by Modified MU EDCA Rules

The AP can apply the following logic.
a. After receiving the last QoS data frame in response to a finer granularity Trigger frame, the AP starts a timer for the MU EDCA Timer duration for those TIDs/TSIDs/SCSIDs. The AP should not receive any non-Trigger Based (TB) Physical Layer Protocol Data Units (PPDUs) from that STA for any of those TIDs/TSIDs/SCSIDs for MU EDCA Timer duration.
b. If the AP receives non-TB PPDUs from that STA for any of those TIDs/TSIDs/SCSIDs before the MU EDCA Timer expires, then the STA is not compliant to modified MU EDCA rules. For such a STA, the AP can take actions to penalize the STA and keep fairness of the MU EDCA operation. For example, the AP can skip triggering the STA (per SCS+QC) for the TIDs/TSIDs/SCSIDs mapped to that AC for which it received the non TB PPDUs. The AP can skip triggering as many times as the number of non TB PPDUs received from that STA during the MU EDCA Timer duration.
c. The AP will also notify the STA of this non-compliant behavior and the consequence of skipping sending triggers to the STA through a management frame, e.g., through an unsolicited SCS Response frame indicating non-compliance through a specific Status code.

Additionally, if the AP receives non-zero BSR Queue size reporting for one or more ACs in the QoS data frames in response to a TF that allows the STA to keep the EDCA enabled for those ACs, but when the AP receives non-TB PPDUs from that STA during the MU EDCA Timer duration and it does not include MPDUs for TIDs mapped to those ACs, this implies that the STA's earlier indication of non-zero BSR for that AC was incorrect and the STA is not accurately reporting its BSR Queue size-reporting non-zero BSR Queue size when in fact the STA does not have any traffic for that AC. If the STA is observed to have this kind of behavior consistently (one or more times), then the STA is not a compliant STA and is trying to cheat on the modified MU EDCA rules. The AP then may take similar corrective actions against such a STA. For example, the AP can skip triggering that STA (per SCS+QC) for the TIDs/TSIDs/SCSIDs mapped to that AC for which STA is not being compliant.

### Per TID/TSID MU EDCA Timer

Currently, the MU EDCA Timer is defined per AC in the MU EDCA Parameters element. However, as more TSIDs are added to an AC, certain TIDs/TSIDs can be more important/higher priority than other TIDs/TSIDs in that AC. In such cases, when modified MU EDCA rules are applied based on per TID/TSID/SCSID, then it may be desired to define a different MU EDCA Timer (i.e., time duration) for each TID/TSID, so that the AP can control the amount of time for which the EDCA is disabled for a TID/TSID. Accordingly, the AP can define an MU EDCA Timer per TID/TSID either Basic Service Set (BSS) wide, in Beacon/Probe Response frames or specific to a STA in the (Re)Association Response frame, SCS Response frame or another management frame. When a per TID/TSID based MU EDCA Timer is defined, then the STA applies the MU EDCA Timer indicated for a given TID/TSID to determine for how long EDCA is disabled for that TID/TSID in the modified rules for MU EDCA per TID/TSID.

This capability is useful in new Wi-Fi use-cases, such as AR/VR/XR and Industrial IOT (IIOT), where the latency bounds between traffic classes in the same AC are dramatically different and thus the MU EDCA Timer value needs to be set according to this delay bound to allow the STA to escape MU-EDCA control and still have a reasonably good chance of accessing the channel via EDCA and achieving the delay requirement.

For modified MU EDCA per TID/TSID, the AP can include a new MU EDCA per TID Parameter Set or an Extended MU EDCA Parameter Set in beacon, Probe Response, (Re)Association Response, SCS Response or another management frame, that defines modified MU EDCA Timer per TID/TSID.

In summary, techniques are provided for rules for modified MU EDCA per TID/TSID/SCSID. The BSR Queue size and finer granularity triggering (per TIDs/TSIDs/SCSIDs) may be included as criteria in deciding to enable modified MU EDCA per TID/TSID/SCID after a TF. The AP can dynamically enable or disable the modified MU EDCA per TID/TSID/SCSID or STA and AP can negotiate to enable modified MU EDCA.

### Transaction Diagram, Message Format, and Flowcharts

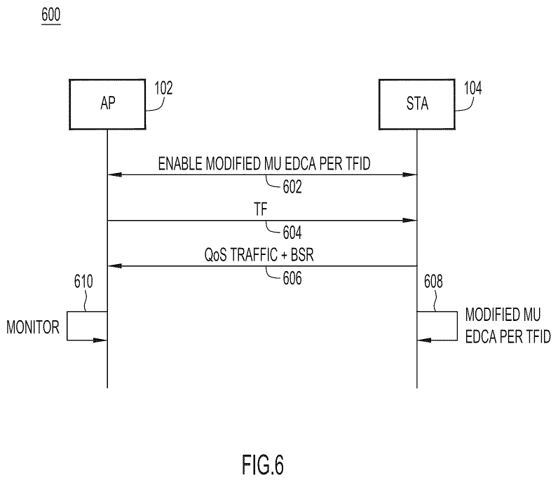

FIG. 6 shows example transactions 600 for modified MU EDCU performed by AP 102 (the AP) and STA 104 (the STA). At 602, the AP and the STA exchange various commands/messages with each other to indicate support for, and enable, modified MU EDCA for the AP and the STA. For example, the AP and the STA indicate to each other support for modified MU EDCA. In an example, the STA and the AP negotiate with each other to enable modified MU EDCA. At 604, the AP transmits to the STA a finer granularity TF with TFIDs for an AC. At 606, the STA responds to the finer granularity TF with QoS traffic and a BSR that indicates a Queue size for buffered QoS traffic at the STA. At 608, the STA implements modified MU EDCA. At 610, the AP monitors the compliance of the STA with modified MU EDCA operations, and takes action to remedy non-compliant behavior.

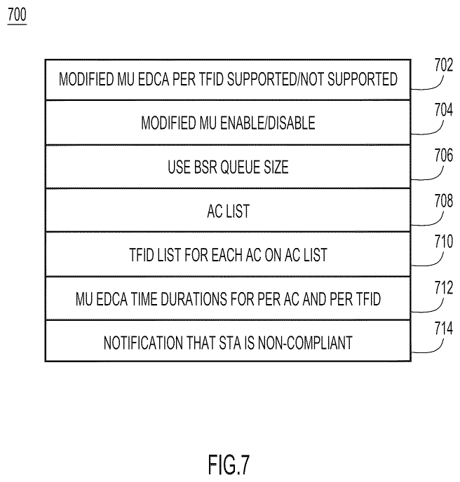

FIG. 7 shows example information elements 700 (or fields) related to modified MU EDCA that may be caried in one or more messages exchanged/transmitted by the AP and/or the STA, and which may be employed by the AP to control the STA. Each of the aforementioned messages may carry some, but not all of information elements 700. The information elements 700 include: a “supported” flag 702 (i.e., an indicator) that indicates that modified MU EDCA is supported or not supported; an enable/disable flag 704 that indicates to the STA to enable or disable modified MU EDCA; a “use BSR Queue size” flag 706 that indicates to the STA to perform modified MU EDCA based on the Queue size, or not perform modified MU EDCA based on the Queue size; an AC list 708 that lists ACs to which modified MU EDCA is to be applied; a TFID list 710 of TFIDs for each AC on the AC list and to which modified MU EDCA is to be applied; MU EDCA timers (i.e., time durations) 712 for each AC and each TFID for each AC; and compliance notification 714 to indicate to the STA that non-compliant STA behavior for modified MU EDCA has been detected.

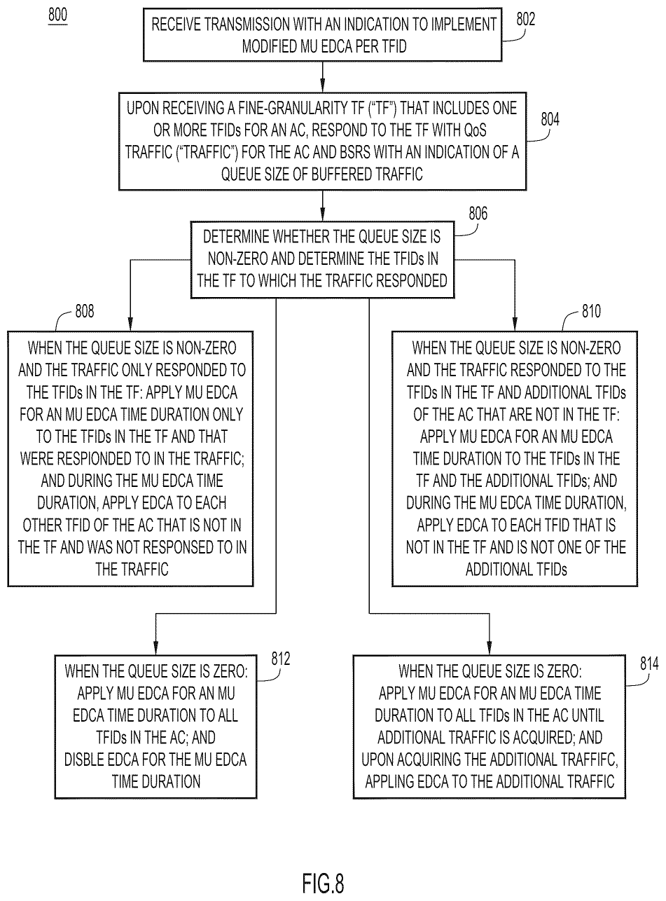

FIG. 8 is a flowchart of an example method 800 performed by a STA to implement modified MU EDCA. Operations of method 800 are described above.

Upon receiving a transmission from an AP to enable modified MU EDCA, at 802, the STA enables modified MU EDCA. The transmission may include a negotiation with the AP to enable modified MU EDCA in the STA.

Upon receiving, from the AP, a fine-granularity TF (referred to below simply as a TF) that includes one or more TFIDs for an AC, at 804, the STA responds to the TF with QoS traffic for the AC and that includes a BSR to indicate a Queue size of buffered QoS traffic (referred to simply as traffic).

At 806, the STA determines whether the Queue size is non-zero and determines the TFIDs in the TF to which the QoS traffic responded (i.e., which of the TFIDs in the TF were responded to). The STA implements modified MU EDCA at one of 808, 810, 812, or 814 based on at least one of the Queue size and which of the TFIDs in the TF were responded to. That is, the Queue size and the responded-to TFIDs represent criteria that form the basis on whether, and how, the STA should implement modified MU EDCA. Generally, to implement modified MU EDCA, the STA applies MU EDCA for an MU EDCA time duration to the one or more TFIDs indicated in the TF. During the MU EDCA time duration (i.e., concurrent with MU EDCA), the STA applies EDCA to one or more other TFIDs of the AC that are not indicated in the TF. When an EDCA backoff time expires within the MU EDCA time duration, the STA sends the buffered traffic only for the one or more other TFIDs that are not in the TF. Variations of the theme are described below.

When the Queue size is non-zero and the traffic only responded to the one or more TFIDs in the TF, at 808, the STA:
a. Applies MU EDCA during the MU EDCA time duration only to the one or more TFIDs in the TF that were responded to in the traffic.
b. Applies EDCA (concurrent with MU EDCA in (a)) to each other TFID of the AC that is not in the TF and was not responded to in the traffic.

When the Queue size is non-zero and the traffic responded to the one or more TFIDs in the TF and one or more additional TFIDs of the AC that are not in the TF, at 810, the STA:
a. Applies MU EDCA during the MU EDCA time duration to (i) the one or more TFIDs in the TF, and (ii) the one or more additional TFIDs.
b. Applies EDCA to each TFID that is not in the TF and is not in the one or more additional TFIDs.

When the Queue size is zero, at 812, the STA:
a. Applies MU EDCA during the MU EDCA time duration to all TFIDs for the AC.
b. Disables EDCA during the MU EDCA time duration for all TFIDs for the AC.

As an alternative to 812, when the Queue size is zero, at 814, the STA:
a. Applies MU EDCA during the MU EDCA time duration to all TFIDs for the AC until the STA acquires additional traffic for TFIDs that were not responded to in the traffic.
b. When the STA acquires the additional traffic, the STA applies EDCA to the additional traffic.

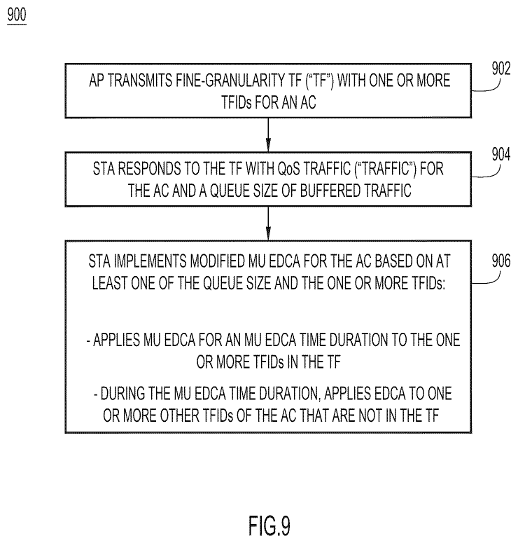

FIG. 9 is a flowchart of an example method 900 performed by a STA and an AP to implement modified MU EDCA. Operations of method 900 are described above.

At 902, the AP transmits a TF that includes one or more TFIDs for an AC.

At 904, the STA responds to the TF with traffic for the AC and a Queue size of buffered QoS traffic.

At 906, the STA implements modified MU EDCA for the AC based on at least one of the Queue size and the one or more TFIDs. The modified MU EDCA is implemented as described above.

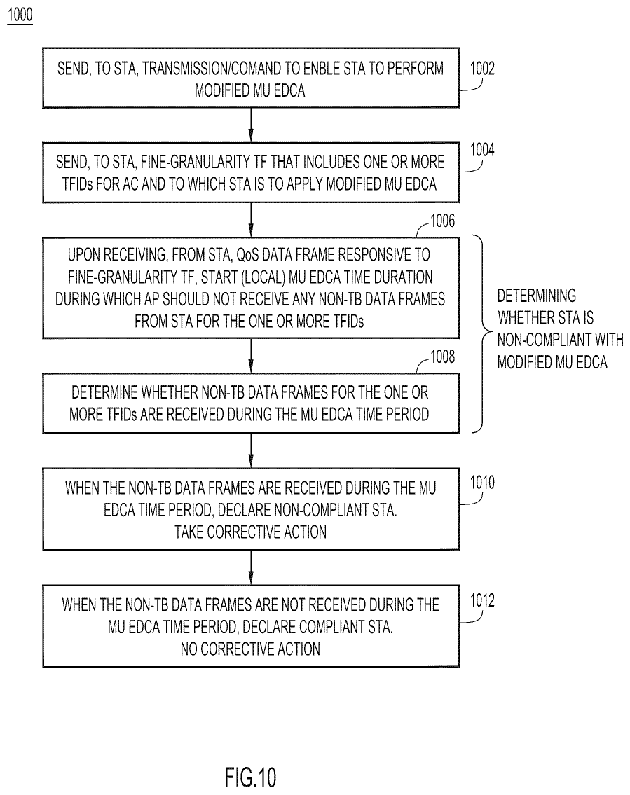

FIG. 10 is a flowchart of an example method 1000 performed by an AP to enable modified MU EDCA at a STA and then monitor compliance of the STA.

At 1002, the AP sends, to the STA, a command (e.g., a message or indicator) to enable the STA to perform modified MU EDCA.

At 1004, the AP sends, to the STA, a fine-granularity TF that includes one or more TFIDs for an AC and to which the STA is to apply modified MU EDCA.

Upon/after receiving, from the STA, a Quality of Service (QoS) data frame responsive to the fine-granularity TF (and after sending, to the STA, a BA to the QoS data frame), at 1006, the AP starts a local MU EDCA time duration during which the STA should not send, and thus the AP should not receive, any non-TB data frames for any of the one or more TFIDs. In an example, the local MU EDCA time duration is equal to an MU EDCA time duration applied by the STA to the one or more TFIDs for the modified MU EDCA. The AP monitors for such transmissions from the STA.

At 1008, the AP determines whether any of the non-TB data frames for the one or more TFIDs are received during the MU EDCA time duration, indicating that the STA is non-compliant with modified MU EDCA. The operations that include (i) starting the local MU EDCA time duration (1006), and (ii) determining whether any of the non-TB data frames for the one or more TFIDs are received during the MU EDCA time duration (1008), are collectively referred to as determining whether the STA is non-compliant with the modified MU EDCA.

When the non-TB data frames are received during the MU EDCA time duration, which indicates non-compliant modified MU EDCA behavior by the STA, at 1010, the AP declares (i.e., determines/decides) that the STA is non-compliant (i.e., is exhibiting non-compliant modified MU EDCA behavior) and performs or takes a corrective action with respect to the STA to correct the non-compliant modified MU EDCA behavior, as described above.

When the non-TB data frames are not received during the MU EDCA time duration, indicating compliant modified MU EDCA behavior by the STA, AT 1012, the AP declares the STA compliant, and does not perform the corrective action.

In summary, embodiments are presented herein for modified MU EDCA depending on traffic or service type. A Queue size, as may be included in a BSR, and finer granularity triggering may be included as criteria in deciding to enable modified MU EDCA after a Trigger frame. An AP can dynamically enable or disable the modified MU EDCA per traffic or service stream, or the STA and AP can negotiate to enable modified MU EDCA.

### Computing Device

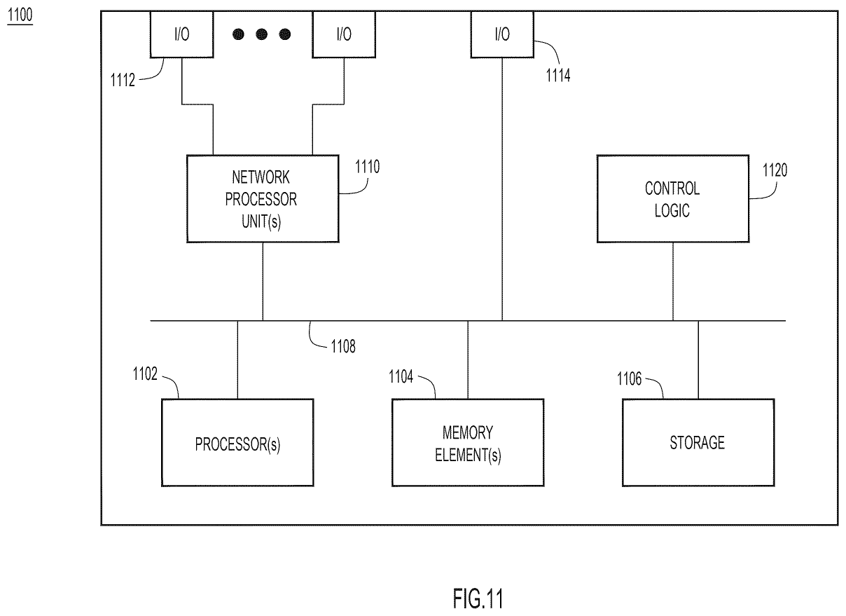

Referring to FIG. 11, FIG. 11 illustrates a hardware block diagram of a device 1100 that may perform functions associated with operations discussed herein in connection with the techniques presented herein. In various embodiments, a computing device or apparatus, such as device 1100 or any combination of devices 1100, may be configured as any entity/entities as discussed for the techniques depicted presented herein in order to perform operations of the various techniques discussed herein. The device 1100 may represent a STA (e.g., a wireless client device), an AP or a wireless network controller.

In at least one embodiment, the device 1100 may be any apparatus that may include one or more processor(s) 1102, one or more memory element(s) 1104, storage 1106, a bus 1108, one or more network processor unit(s) 1110 interconnected with one or more network input/output (I/O) interface(s) 1112, one or more I/O interface(s) 1114, and control logic 1120. In various embodiments, instructions associated with logic for device 1100 can overlap in any manner and are not limited to the specific allocation of instructions and/or operations described herein.

In at least one embodiment, processor(s) 1102 is/are at least one hardware processor configured to execute various tasks, operations and/or functions for device 1100 as described herein according to software and/or instructions configured for device 1100. Processor(s) 1102 (e.g., a hardware processor) can execute any type of instructions associated with data to achieve the operations detailed herein. In one example, processor(s) 1102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1104 and/or storage 1106 is/are configured to store data, information, software, and/or instructions associated with device 1100, and/or logic configured for memory element(s) 1104 and/or storage 1106. For example, any logic described herein (e.g., control logic 1120) can, in various embodiments, be stored for device 1100 using any combination of memory element(s) 1104 and/or storage 1106. Note that in some embodiments, storage 1106 can be consolidated with memory element(s) 1104 (or vice versa), or can overlap/exist in any other suitable manner.

In at least one embodiment, bus 1108 can be configured as an interface that enables one or more elements of device 1100 to communicate in order to exchange information and/or data. Bus 1108 can be implemented with any architecture designed for passing control, data and/or information between processors, memory elements/storage, peripheral devices, and/or any other hardware and/or software components that may be configured for device 1100. In at least one embodiment, bus 1108 may be implemented as a fast kernel-hosted interconnect, potentially using shared memory between processes (e.g., logic), which can enable efficient communication paths between the processes.

In various embodiments, network processor unit(s) 1110 may enable communication between device 1100 and other systems, entities, etc., via network I/O interface(s) 1112 (wired and/or wireless) to facilitate operations discussed for various embodiments described herein. In various embodiments, network processor unit(s) 1110 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 1100 and other systems, entities, etc. to facilitate operations for various embodiments described herein. In various embodiments, network I/O interface(s) 1112 can be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to device 1100. For example, I/O interface(s) 1114 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1120 can include instructions that, when executed, cause processor(s) 1102 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1120) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1104 and/or storage 1106 can store data, software, code, instructions (e.g., processor instructions), logic, parameters, combinations thereof, and/or the like used for operations described herein. This includes memory element(s) 1104 and/or storage 1106 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method performed by a wireless station, the method including: upon receiving, from an access point, a fine-granularity trigger frame that includes one or more traffic flow identifiers (TFIDs) for an access category, responding to the fine-granularity trigger frame with traffic for the access category and an indication of a queue size of buffered traffic; and implementing modified Multi-User Enhanced Distribution Channel Access (MU EDCA) per TFID for the access category based on at least one of the queue size and the one or more TFIDs, wherein the modified MU EDCA per TFID includes: applying MU EDCA for an MU EDCA time duration to the one or more TFIDs in the fine-granularity trigger frame; and during the MU EDCA time duration, applying EDCA to one or more other TFIDs of the access category that are not in the fine-granularity trigger frame.

In some aspects, the techniques described herein relate to a method, further including: when an EDCA backoff time expires within the MU EDCA time duration, sending the buffered traffic in the wireless station only for the one or more other TFIDs that are not in the fine-granularity trigger frame.

In some aspects, the techniques described herein relate to a method, wherein the modified MU EDCA per TFID further includes: when the queue size is non-zero and the traffic only responded to the one or more TFIDs in the fine-granularity trigger frame: applying the MU EDCA includes applying the MU EDCA only to the one or more TFIDs in the fine-granularity trigger frame and that were responded to in the traffic; and applying the EDCA includes applying the EDCA to each other TFID of the access category that is not in the fine-granularity trigger frame and was not responded to in the traffic.

In some aspects, the techniques described herein relate to a method, wherein the modified MU EDCA per TFID further includes: when the queue size is non-zero and the traffic responded to the one or more TFIDs in the trigger frame and one or more additional TFIDs of the access category that are not in the fine-granularity trigger frame: applying the MU EDCA includes applying the MU EDCA to the one or more TFIDs in the fine-granularity trigger frame and the one or more additional TFIDs; and applying the EDCA includes applying the EDCA to each TFID that is not in the fine-granularity trigger frame and is not in the one or more additional TFIDs.

In some aspects, the techniques described herein relate to a method, wherein the modified MU EDCA per TFID further includes: when the queue size is zero: applying the MU EDCA during the MU EDCA time duration to all TFIDs for the access category; and disabling the EDCA for all TFIDs for the access category during the MU EDCA time duration.

In some aspects, the techniques described herein relate to a method, wherein the modified MU EDCA per TFID further includes: when the queue size is zero: applying the MU EDCA during the MU EDCA time duration to all TFIDs for the access category until the wireless station acquires additional traffic for TFIDs that were not responded to in the traffic; and when the wireless station acquires the additional traffic, applying the EDCA to the additional traffic.

In some aspects, the techniques described herein relate to a method, wherein: the one or more TFIDs each includes a traffic identifier.

In some aspects, the techniques described herein relate to a method, wherein: the one or more TFIDs each includes a Stream Classification Service Identifier (SCSID).

In some aspects, the techniques described herein relate to a method, further including: transmitting a STA indication that the wireless station supports the modified MU EDCA per TFID; and upon receiving, from the access point, a transmission that indicates that the access point supports the modified MU EDCA per TFID, implementing the modified MU EDCA per TFID.

In some aspects, the techniques described herein relate to a method, further including: negotiating with the access point to enable the modified MU EDCA per TFID for the one or more TFIDs at the access point and the wireless station.

In some aspects, the techniques described herein relate to a method, wherein the one or more TFIDs include multiple TFIDs, and the method further includes: receiving a transmission that defines multiple MU EDCA time durations for respective ones of the multiple TFIDs, wherein applying the MU EDCA includes applying the one or more MU EDCA for the multiple MU EDCA time durations to the multiple TFIDs.

In some aspects, the techniques described herein relate to an apparatus including: a network interface unit to communicate with a network; and a processor of a wireless station, the processor coupled to the network interface unit and configured to perform: upon receiving, from an access point, a fine-granularity trigger frame that includes one or more traffic flow identifiers (TFIDs) for an access category, responding to the fine-granularity trigger frame with traffic for the access category and an indication of a queue size of buffered traffic; and implementing modified Multi-User Enhanced Distribution Channel Access (MU EDCA) per TFID for the access category based on at least one of the queue size and the one or more TFIDs, wherein the modified MU EDCA per TFID includes: applying MU EDCA for an MU EDCA time duration to the one or more TFIDs in the fine-granularity trigger frame; and during the MU EDCA time duration, applying EDCA to one or more other TFIDs of the access category that are not in the fine-granularity trigger frame.

In some aspects, the techniques described herein relate to an apparatus, wherein the processor is further configured to perform: when an EDCA backoff time expires within the MU EDCA time duration, sending the buffered traffic in the wireless station only for the one or more other TFIDs that are not in the fine-granularity trigger frame.

In some aspects, the techniques described herein relate to an apparatus, wherein the modified MU EDCA per TFID performed by the processor further includes: when the queue size is non-zero and the traffic only responded to the one or more TFIDs in the fine-granularity trigger frame: applying the MU EDCA includes applying the MU EDCA only to the one or more TFIDs in the fine-granularity trigger frame and that were responded to in the traffic; and applying the EDCA includes applying the EDCA to each other TFID of the access category that is not in the fine-granularity trigger frame and was not responded to in the traffic.

In some aspects, the techniques described herein relate to an apparatus, wherein the modified MU EDCA per TFID performed by the processor further includes: when the queue size is non-zero and the traffic responded to the one or more TFIDs in the trigger frame and one or more additional TFIDs of the access category that are not in the fine-granularity trigger frame: applying the MU EDCA includes applying the MU EDCA to the one or more TFIDs in the fine-granularity trigger frame and the one or more additional TFIDs; and applying the EDCA includes applying the EDCA to each TFID that is not in the fine-granularity trigger frame and is not in the one or more additional TFIDs.

In some aspects, the techniques described herein relate to an apparatus, wherein the modified MU EDCA per TFID performed by the processor further includes: when the queue size is zero: applying the MU EDCA during the MU EDCA time duration to all TFIDs for the access category; and disabling the EDCA for all TFIDs for the access category during the MU EDCA time duration.

In some aspects, the techniques described herein relate to an apparatus, wherein the modified MU EDCA per TFID performed by the processor further includes: when the queue size is zero: applying the MU EDCA during the MU EDCA time duration to all TFIDs for the access category until the wireless station acquires additional traffic for TFIDs that were not responded to in the traffic; and when the wireless station acquires the additional traffic, applying the EDCA to the additional traffic.

In some aspects, the techniques described herein relate to an apparatus, wherein: the one or more TFIDs each includes a traffic identifier.

In some aspects, the techniques described herein relate to an apparatus, wherein: the one or more TFIDs each includes a Stream Classification Service Identifier (SCSID).

In some aspects, the techniques described herein relate to a non-transitory computer readable medium encoded with instructions that, when executed by a processor of a wireless station, cause the wireless station to perform: upon receiving, from an access point, a fine-granularity trigger frame that includes one or more traffic flow identifiers (TFIDs) for an access category, responding to the fine-granularity trigger frame with traffic for the access category and an indication of a queue size of buffered traffic; and implementing modified Multi-User Enhanced Distribution Channel Access (MU EDCA) per TFID for the access category based on at least one of the queue size and the one or more TFIDs, wherein the modified MU EDCA per TFID includes: applying MU EDCA for an MU EDCA time duration to the one or more TFIDs in the fine-granularity trigger frame; and during the MU EDCA time duration, applying EDCA to one or more other TFIDs of the access category that are not in the fine-granularity trigger frame.

In some aspects, the techniques described herein relate to a system including: an access point to perform transmitting a fine-granularity trigger frame that includes one or more traffic flow identifiers (TFIDs) for an access category; and a wireless station (STA) to perform: responding to the fine-granularity trigger frame with traffic for the access category and a queue size of buffered traffic; and implementing modified multi-user (MU) Enhanced Distribution Channel Access (EDCA) (MU EDCA) per TFID for the access category based on at least one of the queue size and the one or more TFIDs, wherein the modified MU EDCA per TFID includes: applying MU EDCA for an MU EDCA time duration to the one or more TFIDs in the fine-granularity trigger frame; and during the MU EDCA time duration, applying EDCA to one or more other TFIDs of the access category that are not in the fine-granularity trigger frame.

In some aspects, the techniques described herein relate to a system, wherein the STA is configured to perform implementing the modified MU EDCA per TFID by: when the queue size is non-zero and the traffic only responded to the one or more TFIDs in the fine-granularity trigger frame: applying the MU EDCA includes applying the MU EDCA only to the one or more TFIDs in the fine-granularity trigger frame and that were responded to in the traffic; and applying the EDCA includes applying the EDCA to each other TFID of the access category that is not in the fine-granularity trigger frame and was not responded to in the traffic.

In some aspects, the techniques described herein relate to a system, wherein the STA is configured to perform implementing the modified MU EDCA per TFID by: when the queue size is non-zero and the traffic responded to the one or more TFIDs in the trigger frame and one or more additional TFIDs of the access category that are not in the fine-granularity trigger frame: applying the MU EDCA includes applying the MU EDCA to the one or more TFIDs in the fine-granularity trigger frame and the one or more additional TFIDs; and applying the EDCA includes applying the EDCA to each TFID that is not in the fine-granularity trigger frame and is not in the one or more additional TFIDs.

In some aspects, the techniques described herein relate to a system, wherein the STA is configured to perform implementing the modified MU EDCA per TFID by: when the queue size is zero: applying the MU EDCA during the MU EDCA time duration to all TFIDs for the access category; and disabling the EDCA for all TFIDs for the access category during the MU EDCA time duration.

In some aspects, the techniques described herein relate to a system, wherein: the access point and the STA are configured to negotiate with each other to enable the modified MU EDCA per TFID in the STA.

In some aspects, the techniques described herein relate to a system, wherein the access point is further configured to enable support for the modified MU EDCA for one or more of following: a list of one or more access categories; a list of one or more TFIDs; only for the fine-granularity trigger frame; when a queue size for buffered traffic for the access category reported by the STA is non-zero; or only when the fine-granularity trigger frame explicitly signals that the modified MU EDCA is enabled.

In some aspects, the techniques described herein relate to a method including: by an access point, transmitting a fine-granularity trigger frame that includes one or more traffic flow identifiers (TFIDs) for an access category; and by a wireless station (STA): responding to the fine-granularity trigger frame with traffic for the access category and a queue size of buffered traffic; and implementing modified multi-user (MU) Enhanced Distribution Channel Access (EDCA) (MU EDCA) per TFID for the access category based on at least one of the queue size and the one or more TFIDs, wherein the modified MU EDCA per TFID includes: applying MU EDCA for an MU EDCA time duration to the one or more TFIDs in the fine-granularity trigger frame; and during the MU EDCA time duration, applying EDCA to one or more other TFIDs of the access category that are not in the fine-granularity trigger frame.

In some aspects, the techniques described herein relate to a method, wherein implementing the modified MU EDCA per TFID includes: when the queue size is non-zero and the traffic only responded to the one or more TFIDs in the fine-granularity trigger frame: applying the MU EDCA includes applying the MU EDCA only to the one or more TFIDs in the fine-granularity trigger frame and that were responded to in the traffic; and applying the EDCA includes applying the EDCA to each other TFID of the access category that is not in the fine-granularity trigger frame and was not responded to in the traffic.

In some aspects, the techniques described herein relate to a method, wherein implementing the modified MU EDCA per TFID includes: when the queue size is non-zero and the traffic responded to the one or more TFIDs in the trigger frame and one or more additional TFIDs of the access category that are not in the fine-granularity trigger frame: applying the MU EDCA includes applying the MU EDCA to the one or more TFIDs in the fine-granularity trigger frame and the one or more additional TFIDs; and applying the EDCA includes applying the EDCA to each TFID that is not in the fine-granularity trigger frame and is not in the one or more additional TFIDs.

In some aspects, the techniques described herein relate to a method, wherein implementing the modified MU EDCA per TFID includes: when the queue size is zero: applying the MU EDCA during the MU EDCA time duration to all TFIDs for the access category; and disabling the EDCA for all TFIDs for the access category during the MU EDCA time duration.

In some aspects, the techniques described herein relate to a method, further including: by the access point and by the STA, negotiating with each other to enable the modified MU EDCA per TFID in the STA.

In some aspects, the techniques described herein relate to a method performed by an access point, the method including: transmitting, to a wireless station (STA), a command to enable, at the STA, modified Multi-User Enhanced Distribution Channel Access (MU EDCA) per traffic flow identifier (TFID); transmitting, to the STA, a fine-granularity trigger frame that indicates one or more TFIDs for an access category and to which the STA is to apply the modified MU EDCA per TFID; after receiving, from the STA, a Quality of Service (QoS) data frame responsive to the fine-granularity trigger frame, determining whether the STA is non-compliant with the modified MU EDCA per TFID; when the STA is non-compliant, taking corrective action with respect to the STA; and when the STA is compliant, not taking the corrective action.

In some aspects, the techniques described herein relate to a method, wherein determining includes: starting an MU EDCA time duration during which the STA should not send non-trigger based data frames for the one or more TFIDs; determining whether the non-trigger based data frames are received during the MU EDCA time duration, indicating that the STA is non-compliant; when the non-trigger based data frames are received during the MU EDCA time duration, declaring that the STA is non-compliant; and when the non-trigger based data frames are not received during the MU EDCA time duration, declaring that the STA is compliant.

In some aspects, the techniques described herein relate to a method, wherein taking the corrective action includes one or more of: notifying the STA that the STA is non-compliant; or skipping sending trigger frames to the STA.

In some aspects, the techniques described herein relate to a method, wherein: the modified MU EDCA per TFID includes applying MU EDCA for an MU EDCA time duration to the one or more TFIDs of the access category while applying EDCA to one or more other TFIDs of the access category.

In some aspects, the techniques described herein relate to a method, wherein: starting an MU EDCA time duration during which the STA should not send non-trigger based data frames for the one or more TFIDs; receiving includes receiving, from the STA, the QoS data frame along with a buffer status report of a non-zero queue size for buffered traffic for one or more access categories; and upon receiving non-trigger based traffic during the MU EDCA time duration, and not receiving traffic for the one or more TFIDs, determining that the STA is non-compliant due to inaccurate reporting of the non-zero queue size.

In some aspects, the techniques described herein relate to a method, wherein: transmitting the command to enable the modified MU EDCA per TFID includes transmitting an indication of support for the modified MU EDCA per TFID in an element of a management frame.

In some aspects, the techniques described herein relate to a method, wherein: the element includes an ultra high reliability capabilities element.

In some aspects, the techniques described herein relate to an apparatus including: a network interface unit to communicate with a network; and a processor of an access point, the processor coupled to the network interface unit and configured to cause the processor to perform: causing the access point to transmit, to a wireless station (STA), a command to enable, at the STA, modified Multi-User Enhanced Distribution Channel Access (MU EDCA) per traffic flow identifier (TFID); causing the access point to transmit, to the STA, a fine-granularity trigger frame that indicates one or more TFIDs for an access category and to which the STA is to apply the modified MU EDCA per TFID; after receiving, from the STA, a Quality of Service (QoS) data frame responsive to the fine-granularity trigger frame, determining whether the STA is non-compliant with the modified MU EDCA per TFID; when the STA is non-compliant, taking corrective action with respect to the STA; and when the STA is compliant, not taking the corrective action.

In some aspects, the techniques described herein relate to an apparatus, wherein the processor is configured to perform determining by: starting an MU EDCA time duration during which the STA should not send non-trigger based data frames for the one or more TFIDs; determining whether the non-trigger based data frames are received during the MU EDCA time duration, indicating that the STA is non-compliant; when the non-trigger based data frames are received during the MU EDCA time duration, declaring that the STA is non-compliant; and when the non-trigger based data frames are not received during the MU EDCA time duration, declaring that the STA is compliant.

In some aspects, the techniques described herein relate to an apparatus, wherein the processor is configured to perform taking the corrective action by performing one or more of: notifying the STA that the STA is non-compliant; or skipping sending trigger frames to the STA.

In some aspects, the techniques described herein relate to an apparatus, wherein: the modified MU EDCA per TFID includes applying MU EDCA for an MU EDCA time duration to the one or more TFIDs of the access category while applying EDCA to one or more other TFIDs of the access category.

In some aspects, the techniques described herein relate to an apparatus, wherein the processor is further configured to perform: starting an MU EDCA time duration during which the STA should not send non-trigger based data frames for the one or more TFIDs; receiving, from the STA, the QoS data frame along with a buffer status report of a non-zero queue size for buffered traffic for one or more access categories; and upon receiving non-trigger based traffic during the MU EDCA time duration, and not receiving traffic for the one or more TFIDs, determining that the STA is non-compliant due to inaccurate reporting of the non-zero queue size.

In some aspects, the techniques described herein relate to an apparatus, wherein: The processor is configured to cause the access point to transmit the command to enable the modified MU EDCA per TFID by causing the access point to transmit an indication of support for the modified MU EDCA per TFID in an element of a management frame.

In some aspects, the techniques described herein relate to an apparatus, wherein: the element includes an ultra high reliability capabilities element.

In some aspects, the techniques described herein relate to a non-transitory computer readable medium encoded with instructions that, when executed by a processor of an access point, cause the processor to perform: causing the access point to transmit, to a wireless station (STA), a command to enable, at the STA, modified Multi-User Enhanced Distribution Channel Access (MU EDCA) per traffic flow identifier (TFID); causing the access point to transmit, to the STA, a fine-granularity trigger frame that indicates one or more TFIDs for an access category and to which the STA is to apply the modified MU EDCA per TFID; after receiving, from the STA, a Quality of Service (QoS) data frame responsive to the fine-granularity trigger frame, determining whether the STA is non-compliant with the modified MU EDCA per TFID; when the STA is non-compliant, taking corrective action with respect to the STA; and when the STA is compliant, not taking the corrective action.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method performed by a wireless station, the method comprising:
upon receiving, from an access point, a fine-granularity trigger frame that includes one or more traffic flow identifiers (TFIDs) mapped to an access category, responding to the fine-granularity trigger frame with traffic for the access category; and
implementing modified Multi-User Enhanced Distribution Channel Access (MU EDCA) per TFID for the access category based on at least the one or more TFIDs, wherein the modified MU EDCA per TFID includes:
applying MU EDCA for an MU EDCA time duration to the one or more TFIDs in the fine-granularity trigger frame; and
during the MU EDCA time duration, applying EDCA to one or more other TFIDs of the access category that are not in the fine-granularity trigger frame.

2. The method of claim 1, wherein:
responding to the fine-granularity trigger frame further includers providing an indication of a queue size of buffered traffic for the access category.

3. The method of claim 2, wherein the modified MU EDCA per TFID further includes:
when the queue size is non-zero and the traffic responded to is only for the one or more TFIDs in the fine-granularity trigger frame:
applying the MU EDCA includes applying the MU EDCA only to the one or more TFIDs in the fine-granularity trigger frame and that were responded to in the traffic; and
applying the EDCA includes applying the EDCA to each TFID mapped to the access category that is not in the fine-granularity trigger frame and was not responded to in the traffic.

4. The method of claim 2, wherein the modified MU EDCA per TFID further includes:
when the queue size is non-zero and the traffic responded to is for the one or more TFIDs in the trigger frame and one or more additional TFIDs mapped to the access category that are not in the fine-granularity trigger frame:
applying the MU EDCA includes applying the MU EDCA to the one or more TFIDs in the fine-granularity trigger frame and the one or more additional TFIDs; and
applying the EDCA includes applying the EDCA to each TFID mapped to the access category that is not in the fine-granularity trigger frame and is not in the one or more additional TFIDs.

5. The method of claim 2, wherein the modified MU EDCA per TFID further includes:
when the queue size is zero:
applying the MU EDCA during the MU EDCA time duration to all of the TFIDs mapped to the access category; and
disabling the EDCA for all of the TFIDs mapped to the access category during the MU EDCA time duration.

6. The method of claim 2, wherein the modified MU EDCA per TFID further includes:
when the queue size is zero:
applying the MU EDCA during the MU EDCA time duration to all of the TFIDs mapped to the access category until the wireless station acquires additional traffic for TFIDs that were not responded to in the traffic; and
when the wireless station acquires the additional traffic, applying the EDCA to the additional traffic.

7. The method of claim 2, further comprising:
when an EDCA backoff time expires within the MU EDCA time duration, sending the buffered traffic in the wireless station only for the one or more other TFIDs that are not in the fine-granularity trigger frame.

8. The method of claim 1, wherein the one or more TFIDs each includes a traffic identifier (TID) value from 0 to 7 or a traffic stream identifier (TSID) value from 8 to 15.

9. The method of claim 1, wherein the one or more TFIDs each includes a Stream Classification Service Identifier (SCSID).

10. The method of claim 1, further comprising:
transmitting a STA indication that the wireless station supports the modified MU EDCA per TFID; and
upon receiving, from the access point, a transmission that indicates that the access point supports the modified MU EDCA per TFID, implementing the modified MU EDCA per TFID.

11. The method of claim 1, further comprising:
negotiating with the access point to enable the modified MU EDCA per TFID for the one or more TFIDs at the access point and the wireless station.

12. The method of claim 1, wherein the one or more TFIDs include multiple TFIDs, and the method further comprises:
receiving a transmission that defines multiple MU EDCA time durations for respective ones of the multiple TFIDs,
wherein applying the MU EDCA includes applying the one or more MU EDCA for the multiple MU EDCA time durations to the multiple TFIDs.

13. A system comprising:
an access point to perform transmitting a fine-granularity trigger frame that includes one or more traffic flow identifiers (TFIDs) mapped to an access category; and
a wireless station (STA) to perform:
responding to the fine-granularity trigger frame with traffic for the access category; and
implementing modified multi-user (MU) Enhanced Distribution Channel Access (EDCA) (MU EDCA) per TFID for the access category based on at least the one or more TFIDs, wherein the modified MU EDCA per TFID includes:
applying MU EDCA for an MU EDCA time duration to the one or more TFIDs in the fine-granularity trigger frame; and
during the MU EDCA time duration, applying EDCA to one or more other TFIDs mapped to the access category that are not in the fine-granularity trigger frame.

14. The system of claim 13, wherein:
responding to the fine-granularity trigger frame further includers providing an indication of a queue size of buffered traffic for the access category.

15. The system of claim 14, wherein the STA is configured to perform implementing the modified MU EDCA per TFID by:
when the queue size is non-zero and the traffic only responded to the one or more TFIDs in the fine-granularity trigger frame:
applying the MU EDCA includes applying the MU EDCA only to the one or more TFIDs in the fine-granularity trigger frame and that were responded to in the traffic; and
applying the EDCA includes applying the EDCA to each other TFID mapped to the access category that is not in the fine-granularity trigger frame and was not responded to in the traffic.

16. The system of claim 14, wherein the STA is configured to perform implementing the modified MU EDCA per TFID by:
when the queue size is non-zero and the traffic responded to the one or more TFIDs in the trigger frame and one or more additional TFIDs mapped to the access category that are not in the fine-granularity trigger frame:
applying the MU EDCA includes applying the MU EDCA to the one or more TFIDs in the fine-granularity trigger frame and the one or more additional TFIDs; and
applying the EDCA includes applying the EDCA to each TFID that is not in the fine-granularity trigger frame and is not in the one or more additional TFIDs.

17. The system of claim 14, wherein the STA is configured to perform implementing the modified MU EDCA per TFID by:
when the queue size is zero:
applying the MU EDCA during the MU EDCA time duration to all of the TFIDs mapped to the access category; and
disabling the EDCA for all of the TFIDs mapped to the access category during the MU EDCA time duration.

18. The system of claim 13, wherein the access point and the STA are configured to negotiate with each other to enable the modified MU EDCA per TFID in the STA.

19. The system of claim 13, wherein the access point is further configured to enable support for the modified MU EDCA for one or more of following:
a list of one or more access categories;
a list of one or more TFIDs;
only for the fine-granularity trigger frame;
when a queue size for buffered traffic for the access category reported by the STA is non-zero; or
only when the fine-granularity trigger frame explicitly signals that the modified MU EDCA is enabled.

20. A method performed by an access point, the method comprising:
transmitting, to a wireless station (STA), a command to enable, at the STA, modified Multi-User Enhanced Distribution Channel Access (MU EDCA) per traffic flow identifier (TFID);
transmitting, to the STA, a fine-granularity trigger frame that indicates one or more TFIDs mapped to an access category and to which the STA is to apply the modified MU EDCA per TFID;
after receiving, from the STA, a Quality of Service (QoS) data frame responsive to the fine-granularity trigger frame, determining whether the STA is non-compliant with the modified MU EDCA per TFID;
when the STA is non-compliant, taking correcting action with respect to the STA; and
when the STA is compliant, not taking the corrective action.

21. The method of claim 20, wherein determining includes:
starting an MU EDCA time duration during which the STA should not send non-trigger based data frames for the one or more TFIDs;
determining whether the non-trigger based data frames are received during the MU EDCA time duration, indicating that the STA is non-compliant;
when the non-trigger based data frames are received during the MU EDCA time duration, declaring that the STA is non-compliant; and
when the non-trigger based data frames are not received during the MU EDCA time duration, declaring that the STA is compliant.

22. The method of claim 20, wherein taking corrective action includes one or more of:
notifying the STA that the STA is non-compliant; or
skipping sending trigger frames to the STA.

23. The method of claim 20, wherein the modified MU EDCA per TFID includes applying MU EDCA for an MU EDCA time duration to the one or more TFIDs mapped to the access category while applying EDCA to one or more other TFIDs of the access category.
